(19) United States
(12) Patent Application Publication
(10) Pub. No.: US 2006/0114797 A1
(43) Pub. Date: Jun. 1, 2006

(54) Optical pickup device with variable refractive index

(75) Inventors: Suk Ho Jung, Gyeonggi-do (KR); Young Joo Kim, Gyeonggi-do (KR); Chon Su Kyong, Seoul (KR); In Cheol Chang, Gyeonggi-do (KR); Ho Seop Jeong, Gyeonggi-do (KR)

Correspondence Address: DARBY & DARBY P.C., P. O. BOX 5257, NEW YORK, NY, 10150-5257, US

(73) Assignee: Samsung Electro-Mechanics Co., Ltd., Gyeonggi-do (KR)

(21) Appl. No.: 11/290,955

(22) Filed: Nov. 29, 2005

(30) Foreign Application Priority Data
Nov. 29, 2004 (KR) 10-2004-0098716

(51) Int. Cl. G11B 7/00

(52) U.S. Cl. 369/112.01

(57) ABSTRACT

Disclosed is an optical pickup device having a variable refractive index, comprising a radiating element for radiating light beams; an objective lens for focusing the light beams onto an optical disc; a photodetector for receiving light beams reflected from the optical disc; and a variable refractive index element, connected to an external electrical field, for refracting and transmitting the light beams from the radiating element onto the objective lens.

### INCORPORATION BY REFERENCE

The present application claims priority under 35 U.S.C. §119 to Korean Patent Application No. 10-2004-0098716 filed on Nov. 29, 2004. The content of the application is incorporated herein by reference in its entirety.

### BACKGROUND OF THE INVENTION

1. Field of the Invention

The present invention is in the field of optical pickup devices. More particularly, the present invention relates to an optical pickup device with a variable refractive index, which can read information from an optical disc having multiple recordable layers.

2. Description of the Related Art

An optical pickup is a device that writes on or reads from optical discs by radiating light beams onto the optical discs and receiving beams reflected therefrom.

With the rapid increase in demand for data storage, Blu ray, also known as Blu ray discs (BDs), have been developed as a substitute for CDs and DVDs. In this regard, many advances have been achieved for increasing the recording density of optical discs, and extensive research is actually in progress.

The recording density of an optical disc is in direct proportion to the numerical aperture (NA) of the objective lens and in inverse proportion to the wavelength of incident beams. Thus, BDs onto which a light beam of 405 nm is radiated and which have an NA of 0.85, are of high interest.

However, under the conditions of a large numerical aperture and a short wavelength, spherical aberrations due to variation in disc thickness tend to expand, therefore requiring compensation therefor. Reduction of spherical aberrations due to variation in disc thickness is disclosed in Japanese Pat. Publication No. 2004-103110, entitled “Objective lens and optical pickup device”, the structure of which is illustrated in FIG. 12.

As depicted in FIG. 12, an objective lens module 200, which concentrates light beams transmitted from a quarter wave plate (not shown) onto a signal-recording plane 103 on an optical disc 100, consists of two objective lenses: a first objective lens 201 standing on the side of the quarter wave plate, and a second objective lens 202 positioned at a predetermined distance from the first objective lens 201, facing the optical disc 100. The shape and refractive index of the first and second objective lenses 201 and 202, which determine the total refractive index of the objective lens 200, are controlled in consideration of the thickness and refractive index of the transparent layer 102 of the optical disc 100 so as to focus the light beams transmitted from the quarter wave plate onto the recording plane 103 of the optical disc 100 without the occurrence of aberration.

The first objective lens 201 is an aspherical convex lens which has a convex surface toward the quarter wave plate. Upon being incident on the first objective lens 201, light beams are refracted at the interface between air and the convex part and therefore converge. Upon being emergent from the first objective lens 201, the convergent light beams are refracted again at the interface between the surface of the lens on the side of the optical disc 100 and the air.

The second objective lens 202 includes a plano-convex lens 203, two glass plates 204 and 206, and a liquid crystal element 205. In the plano-convex lens 203, the convex surface is directed toward the first objective lens 201 while the flat plane perpendicular to the optical axis stands on the side of the optical disc 100. A pair of glass plates 204 and 205 with the liquid crystal element 205 disposed between is positioned in contact with the flat plane of the second objective lens 202.

The liquid crystal element 205 is arranged so that its incident and emergent planes are perpendicular to the optical axis of the objective lens module 200. An electrical field can be applied across the liquid crystal element 205 via electrode films (not shown) provided to both its sides. Upon the application of an external electrical field, the refractive index of the liquid crystal element varies by an amount depending on the magnitude of the voltage. This change in refractive index allows the light beams passing through the liquid crystal element 205 to take a different path so as to correct spherical aberration due to variation in disc thickness.

In the structure of the conventional optical pickup, however, the light beams refract to such a small extent as to compensate for spherical aberrations due to variation in disc thickness as small as approximately 3 μm because the refractive index variable member is a flat plate type. Thus, the conventional optical pickup device cannot be used where optical discs have large variations in thickness or where multiple recording layers are formed in BDs which are approximately 100 μm thick.

Besides, most conventional optical pickup devices have complex structures and are heavy because they require additional objective lenses for correcting the spherical aberration caused by variation in disc thickness, in addition to a basic objective lens.

### SUMMARY OF THE INVENTION

Accordingly, the present invention has been made keeping in mind the above problems occurring in the prior art, and an object of the present invention is to provide an optical pickup device which can expand the range of correction for spherical aberration due to variation in the thickness of optical discs by employing a variable refractive index element in which at least two sheets of liquid crystal portions with a curvature incident and/or emergent surface are included and the refractive index of which varies according to an external electric field applied to the element, in addition to being simple in structure and having a light weight because of requirement for no additional objective lenses.

In accordance with an aspect of the present invention, there is provided an optical pickup device with a variable refractive index, comprising: a radiating element for radiating light beams; an objective lens for focusing the light beams onto an optical disc; a photodetector for receiving light beams reflected from the optical disc; and a variable refractive index element, connected to an external electrical field, for refracting and transmitting the light beams from the radiating element onto the objective lens, said variable refractive index element having incident and emergent surfaces at least one of which has a predetermined curvature radius and showing a refractive index which varies by an amount depending on the magnitude of the external electrical field applied thereto.

In accordance with another aspect of the present invention, there is provided an optical pickup device with a variable refractive index, comprising: a radiating element for radiating light beams; a collimate lens for collimating the light beams from the radiating element; an objective lens for focusing the light beams onto an optical disc; a photodetector for receiving light beams reflected from the optical disc; and a variable refractive index element, built in the collimate lens and connected to an external electrical field, for refracting and transmitting the light beams from the radiating element onto the objective lens, said variable refractive index element having incident and emergent surfaces at least one of which has a predetermined curvature radius and showing a refractive index which varies by an amount depending on the magnitude of the external electrical field applied thereto.

In the optical pickup device, the variable refractive index element is a multilayer structure comprising a plurality of transparent protecting portions and a plurality of liquid crystal portions, in which the transparent protecting portions alternate with the liquid crystal portions while constituting the outermost surfaces of the variable refractive index element with regard to the propagation direction of the light beams, said liquid crystal portions having incident and emergent surfaces at least one of which has a predetermined curvature and showing a refractive index which varies by an amount depending on the magnitude of the external electrical field applied thereto.

In the optical pickup device, the plurality of liquid crystal portions comprises at least one spherical or aspherical concave lens type-liquid crystal portion, the concave surface of which serves as an incident plane and at least one spherical or aspherical convex lens type-liquid crystal portion, the convex surface of which serves as an emergent plane.

In the optical pickup device, the plurality of liquid crystal portions comprises a pair of convex lens type-liquid crystal portions which are spherical or aspherical, each having a convex surface serving as an incident plane.

In the optical pickup device, the plurality of liquid crystal portions comprises at least one meniscus liquid crystal portion which is spherical or aspherical.

In the optical pickup device, each of the liquid crystal portions has a thickness ranging from 6 to 40 μm and a curvature range of 45.145 to 280 mm, and its refractive index may be linearly changed in the range of 1.5 to 1.72.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic view showing a structure of an optical pickup device according to an embodiment of the present invention;

FIG. 2 is a schematic cross sectional view showing a variable refractive index element according to the embodiment of FIG. 1;

FIG. 3 is a schematic cross sectional view showing liquid crystal portions of the variable refractive index element of FIG. 2;

FIG. 4A is a schematic cross sectional view showing a state of a molecular arrangement of the liquid crystal portions in the absence of an external electric field;

FIG. 4B is a schematic cross sectional view showing a state of a molecular arrangement of the liquid crystal portions in the presence of an external electric field;

FIG. 5 is a schematic view showing optical paths of the light beams passing through the variable refractive index element of FIG. 2;

FIG. 6 is a schematic view showing optical paths of the light beams passing through a variable refractive index element according to another embodiment of the optical pickup device of FIG. 1;

FIG. 7 is a schematic view showing optical paths of the light beams passing through a variable refractive index element according to a further embodiment of the optical pickup device of FIG. 1;

FIG. 8 is a schematic view showing a structure of an optical pickup device according to another embodiment of the present invention;

FIG. 9 is a schematic cross sectional view showing a collimate lens according to an embodiment of the optical pickup device of FIG. 8;

FIG. 10 is a schematic view showing optical paths of the light beams passing through the collimate lens of FIG. 9;

FIG. 11 is a schematic view showing optical paths of the light beams passing through a collimate lens according to another embodiment of the optical pickup device of FIG. 8; and

FIG. 12 is a schematic view showing a part of a conventional optical pickup device.

### DETAILED DESCRIPTION OF THE INVENTION

Reference now should be made to the drawings, in which the same reference numerals are used throughout the different drawings to designate the same or similar components.

A description will be given of embodiments of optical pickup devices which are adapted to BDs. If different optical discs, CDs or DVDs, are used, necessary parts such as objective lenses may be modified or supplemented.

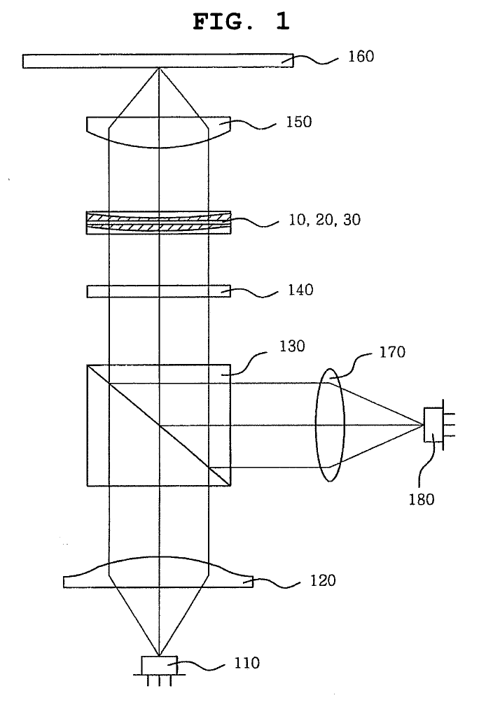

With reference to FIG. 1, an optical pickup device 100 according to an embodiment of the present invention is shown which comprises a radiating element 110, a collimate lens 120, a polarized beam splitter 130, a quarter wave plate 140, variable refractive index elements 10, 20 and 30, an objective lens 150, a focal lens 170, and a photodetector 180.

After being emitted from the radiating element 110, 405 nm blue light beams with a plane of polarization are transmitted to the collimate lens 120.

In the collimate lens 120, all of the optical paths that the light beams follow after the light source are made to be almost parallel to the optical axis. The parallel light is directed to the polarized beam splitter 130.

The polarized beam splitter 130 allows the parallel light, which is linearly polarized light with a plane of polarization, to pass therethrough, but reflects at a right angle the light reflected from an optical disc. After passing through the polarized beam splitter 130, the parallel light goes to the quarter wave plate 140 while the light reflected at a right angle from the polarized beam splitter 130 is directed to the focal lens 170.

The quarter wave plate 140 rotates the electrical field component of the parallel light incident thereon to turn linearly polarized light into circularly polarized light and vice versa. Thus, the linearly polarized light incident on the quarter wave plate 140 is changed into circularly polarized light which is then transmitted to the variable refractive index elements 10, 20 and 30. On the other hand, the light reflected from the optical disc 160 changes from circularly polarized light to linearly polarized light in the quarter wave plate 140 before being sent to the polarized beam splitter 130.

Before traveling to the objective lens 150, the circularly polarized light incident on the variable refractive index elements 10, 20 and 30 undergoes variable refraction because refractive indices of the variable refractive index elements 10, 20 and 30 change in accordance with an externally applied electric field.

Through the objective lens 150, the circularly polarized light beams transmitted from the variable refractive index elements 10, 20 and 30 converge onto a recording plane of a corresponding layer formed on the optical disc 160. Also, the objective lens 150 serves to collimate the light beams reflected from the optical disc. The collimated light beams pass through the variable refractive index elements 10, 20 and 30, followed by being linear polarized in the quarter wave plate 140.

The optical disc BD has a multilayer recording plane structure. Light beams, which are refracted at different indices depending on the external electric field applied to the variable refractive index elements 10, 20 and 30, are focused on an optical spot on the multilayer recording planes in the BD. By controlling the electric field, the optical spot can be accurately formed on a desired recording plane. Thus, it is possible to read the information stored on the multilayer recording planes.

Positioned between the polarized beam splitter 130 and the photodetector 180, the focal lens 170 converges the light reflected from the polarized beam splitter 130 into the photodetector 180 which converts the reflected light into electrical signals to read the information.

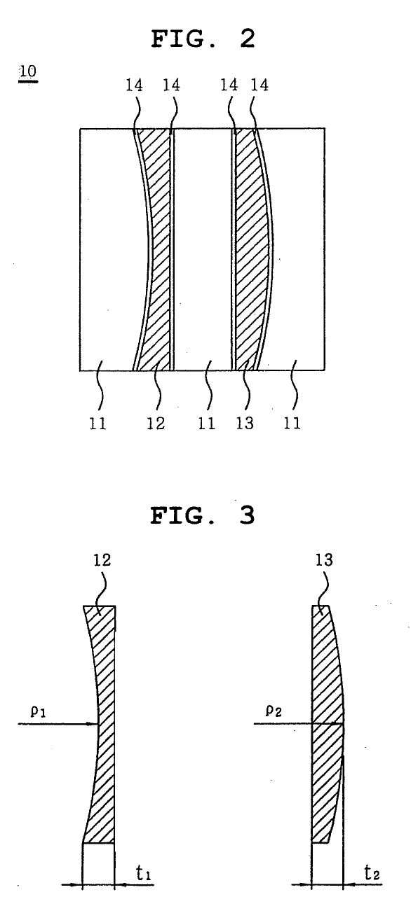

The variable refractive index elements applied to the optical pickup device of FIG. 1 can be structured in various formats which are explained in detail with reference to FIGS. 2 to 7.

FIG. 2 shows a liquid crystal module 10, which comprises triple glass plates 11 and two liquid crystal portions 12 and 13, each being interposed between the glass plates 11. In this embodiment, the liquid crystal portions 12 and 13 are concave and convex, respectively.

On both sides of each of the concave lens type- and the convex lens type-liquid crystal portions 12 and 13 are formed optically transparent electrode films 14 with which an external electric field can be applied across each of the liquid crystal portions 12 and 13.

The concave lens type-liquid crystal portion 12, as shown in FIG. 3, has a total thickness of t₁ and is a plano-concave type with one concave surface having a curvature radius of ρ₁ and facing the light source, and one flat surface facing the objective lens. Thus, the concave surface serves as an incident plane while the flat surface serves as an emergent plane.

On the other hand, the convex lens type-liquid crystal portion is a plano-convex type with a total thickness of t₂ and a curvature radius of ρ₂. It is disposed in such a manner that the flat surface faces the light source, serving as an incident plane while the convex surface faces the objective lens, serving as an emergent plane.

Each of the thicknesses t₁ and t₂ of the concave lens type- and the convex lens type-liquid crystal portion 12 and 13 falls into the range of 6 to 40 μm and is preferably 10 μm. As for the curvature radii ρ₁ and ρ₂, each of them ranges from 45.145 to 280 mm and is preferably 144.5 mm. The thickness of each of the liquid crystal portions 12 and 13 is preferably dependent on the external electric field applied to the liquid crystal portions 12 and 13. For instance, the thickness is preferably set to be 10 μm if 10V is applied. The thickness is preferably increased to 20 μm with an external electric field of 20 V. Of course, the refractive indices of the liquid crystal portions 12 and 13 vary with the thickness.

The following descriptions will be made on the basis of liquid crystal portions that are 10 μm thick when account is taken of the fact that an external electric field applied to an optical pickup device generally has a voltage of 10V.

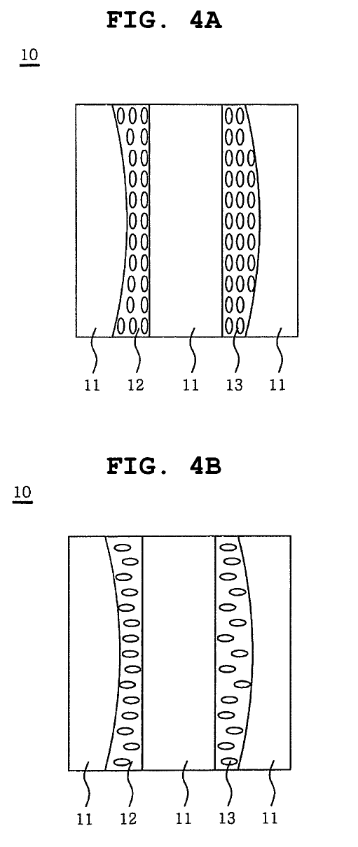

In the absence of external electric fields, as shown in FIG. 4A, liquid crystal particles are in a stable state. Under this condition, the liquid crystal portions 12 and 13 show refractive indices n₁=n₂=1.72 while the refractive index nₐ of air is 1 and the refractive index n_{g} of the glass plates 11 is 1.5.

When 5V are applied across each of the liquid crystal portions 12 and 13, the liquid crystal particles, as shown in FIG. 4B, are in an unstable state. In this condition, the refractive indices of the liquid crystal portions 12 and 13 are changed to n₁=n₂=1.61 while nₐ=1 and n_{g}=1.5. In the presence of 10V, their, refractive indices are decreased to n₁=n₂=1.5 while nₐ=1 and n_{g}=1.5. The respective change of refractive index from 1.72 to 1.61 and 1.5 at external voltages of 5V and 10V is attributed to the fact that the refractive indices of the liquid crystal portions 12 and 13 change with the applied external voltages in corresponding local regions.

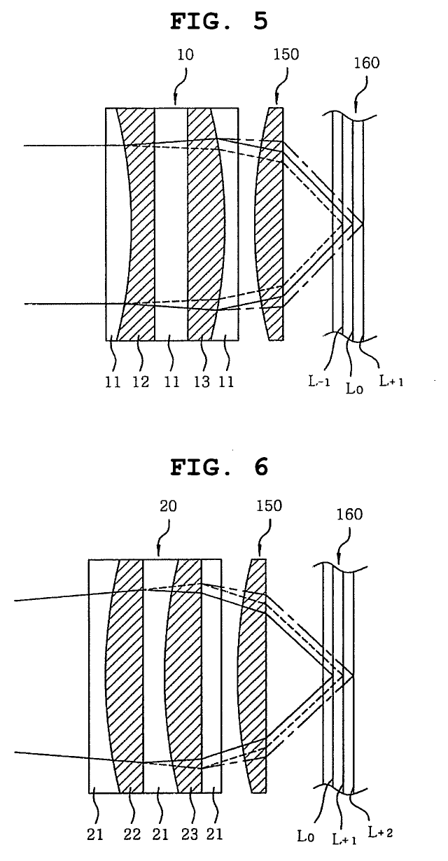

FIG. 5 depicts the refraction of light beams depending on the external voltages applied to the liquid crystal portions 12 and 13 of the variable refractive index element 10 in the structure of the optical pickup device according to one embodiment of the present invention.

When no external electric field is applied, that is, when the glass plates 11, the concave lens type-liquid crystal portion 12 and the convex lens type-liquid crystal portion 13 have refractive indices of 1.5, 1.72 and 1.72, respectively, the parallel light beams incident on the variable refractive index element 10, as indicated by solid lines, are diverged by the concave lens type-liquid crystal portion 12 and then converged by the convex lens type-liquid crystal portion 13, followed by the concentration of the light beams by the objective lens 150 to form an optical spot on a recording plane at position L₀ in the multilayer structure of the optical disc 160.

On the other hand, when 10 V are applied across the concave lens type-liquid crystal portion 12, its refractive index is changed to 1.5 while the refractive indices of the glass plates 11 and the convex lens type-liquid crystal portion 13 remain at 1.5 and 1.72, respectively. In this circumstance, the parallel light beams incident on the variable refractive index element 10, as indicated by dotted lines, travel the concave lens type-liquid crystal portion 12 without alternation of the optical path and then are converged by the convex lens type-liquid crystal portion 13. Thereafter, the convergent light beams are focused by the objective lens 150 onto an optical spot on a recording plane at position L₋₁ in the multilayer structure of the optical disc 160.

Application of 5V to the concave lens type-liquid crystal portion 12 causes its refractive index to change to 1.61. In this case (not shown), the parallel light beams incident on the variable refractive index element 10 diverge at a smaller angle than when 10 V are applied, and then converge while passing through the convex lens type-liquid crystal portion 13. The convergent light beams are further converged by the objective lens 150 to form an optical spot on a virtual recording plane present between positions L₀ and L₋₁ in the optical disc 160.

Where an external electric field of 10 V is applied across the convex lens type-liquid crystal portion 13, that is, where the convex lens type-liquid crystal portion 13 is set to have a refractive index of 1.5 while the refractive indices of the glass plates 11 and the concave lens type-liquid crystal portion 12 remain at 1.5 and 1.72, respectively, the parallel light beams incident on the variable refractive index element 10, as indicated by dot and dashed lines, are diverged by the concave lens type-liquid crystal portion 12 and then converged by the convex lens type-liquid crystal portion 13 at a smaller angle in relation to when no external electric field is applied. Thereafter, the convergent light beams are focused by the objective lens 150 onto an optical spot on a recording plane at position L₊₁ in the multilayer structure of the optical disc 160.

The application of 5V to the convex lens type-liquid crystal portion 13 causes its refractive index to change to 1.61. In this case (not shown), the parallel light beams incident on the variable refractive index element 10 are diverged by the concave lens type-liquid crystal portion 12 and then converged by the convex lens type-liquid crystal portion 13 at a larger angle than when 10 V are applied. The convergent light beams are further converged by the objective lens 150 to form an optical spot on a virtual recording plane present between positions L₀ and L₊₁ in the optical disc 160.

In FIG. 6, a different type of a variable refractive index element 20 is introduced which comprises a pair of convex lens type-liquid crystal portions 22 and 23 in accordance with another embodiment. The variable refractive index element 20 has the same structure as in FIG. 5, with the exception that all of the liquid crystal portions are a plano-convex type and thus, a description of this variable refractive index element 20 is omitted. FIG. 6 depicts the refraction of light beams depending on the external voltages applied to the liquid crystal portions 22 and 23 of the variable refractive index element 20 in the structure of the optical pickup device.

In the case of employing a pair of convex lens type-liquid crystal portions 22 and 23, the optical pickup device is preferably designed so that the light beams are slightly divergent upon being incident on the variable refractive index element 20. To this end, an additional diverging means may be installed or the positional relationship of other related parts may be changed.

In this embodiment, as shown in FIG. 6, the convex lens type-liquid crystal portions 22 and 23 are arranged in such a manner that both of the convex surfaces thereof are directed toward the radiating element (not shown). Of course, other arrangements may be used. For example, an arrangement design may be used in which the convex surface of one convex lens type-liquid crystal portion faces the radiating element while the convex surface of the other convex lens type-liquid crystal portion is directed toward the objective lens 150. Alternatively, both of the convex surfaces may be arranged to face the objective lens 150. In order to expand the range of compensation for spherical aberrations due to variation in disc thickness, however, it is preferred that both of the convex surfaces of the convex lens type-liquid crystal portions 22 and 23 stand facing the radiating element.

In the absence of the application of an external electric field, that is, when glass plates 21 and the pair of convex lens type-liquid crystal portions 22 and 23 have refractive indices of 1.5, 1.72 and 1.72, respectively, slightly divergent light beams incident on the variable refractive index element 20, as indicated by solid lines, are converged several times by the convex lens type-liquid crystal portions 22 and 23, followed by the concentration of the light beams by the objective lens 150 to form an optical spot on a recording plane at position L₀ in the multilayer structure of the optical disc 160.

On the other hand, when 10 V are applied across the convex lens type-liquid crystal portion 22, its refractive index is changed to 1.5 while the refractive indices of the glass plates 21 and the convex lens type-liquid crystal portion 23 remain at 1.5 and 1.72, respectively. In this circumstance, the divergent light beams incident on the variable refractive index element 20, as indicated by dotted lines, travel the convex lens type-liquid crystal portion 22 without alternation of the optical path and then are converged by the convex lens type-liquid crystal portion 23. Thereafter, the convergent light beams are focused by the objective lens 150 onto an optical spot on a recording plane at position L₊₁ in the multilayer structure of the optical disc 160.

The application of 5V to the convex lens type-liquid crystal portion 22 causes the refractive index to change to 1.61. In this case (not shown), the divergent light beams incident on the variable refractive index element 20 converge at a smaller angle relative to when no external electric field is applied, and then further converge while passing through the convex lens type-liquid crystal portion 23. The convergent light beams are concentrated by the objective lens 150 to form an optical spot on a virtual recording plane between positions L₀ and L₊₁ in the optical disc 160.

Where an external electric field of 10 V is applied across both of the convex lens type-liquid crystal portions 22 and 23, that is, where all the glass plates 21 and the convex lens type-liquid crystal portions 22 and 23 have the same refractive index of 1.5, the divergent light beams incident on the variable refractive index element 20, as indicated by dot and dashed lines, pass through the convex lens type-liquid crystal portions 22 and 23 without alteration of the optical path and then converge outside the convex lens type-liquid crystal portion 23. Thereafter, the convergent light beams are focused by the objective lens 150 onto an optical spot on a recording plane at position L₊₂ in the multilayer structure of the optical disc 160.

Both of the convex lens type-liquid crystal portions 22 and 23 have a refractive index of 1.61 if 5V are applied thereto. In this case (not shown), the divergent light beams incident on the variable refractive index element 20 are converged by the convex lens type-liquid crystal portion 22 at a smaller angle than when no external electric field is applied. This convergence at a relatively smaller angle is repeated by the convex lens type-liquid crystal portion 23. The convergent light beams are further converged by the objective lens 150 to form an optical spot on a virtual recording plane present between positions L₁ and L₊₂ in the optical disc 160.

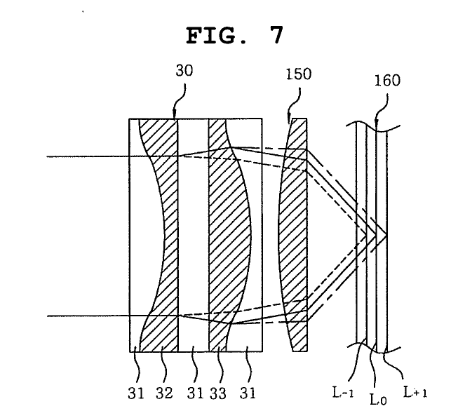

FIG. 7 shows a variable refractive index element 30 in accordance with another embodiment of the present invention, which has the same structure as in FIG. 5, with the exception that the liquid crystal portions of the variable refractive index element 30 are aspherical and thus, a description of this variable refractive index element 30 is omitted. In FIG. 7, the refraction of light beams depending on the external voltages applied to the aspherical liquid crystal portions 32 and 33 of the variable refractive index element 30 in the structure of the optical pickup device is depicted according to another embodiment.

When no external electric field is applied, that is, when glass plates 31, the aspherical concave lens type-liquid crystal portion 32, and the aspherical convex lens type-liquid crystal portion 33 has refractive indices of 1.5, 1.72 and 1.72, respectively, the parallel light beams incident on the variable refractive index element 30, as indicated by solid lines, are diverged by the aspherical concave lens type-liquid crystal portion 32 and then converged by the aspherical convex lens type-liquid crystal portion 33, followed by the concentration of the light beams by the objective lens 150 to form an optical spot on a recording plane at position L₀ in the multilayer structure of the optical disc 160.

On the other hand, when 10 V are applied across the aspherical concave lens type-liquid crystal portion 32, its refractive index is changed to 1.5 while the refractive indices of the glass plates 31 and the convex lens type-liquid crystal portion 33 remain at 1.5 and 1.72, respectively. In this circumstance, the parallel light beams incident on the variable refractive index element 30, as indicated by dotted lines, travel through the aspherical concave lens type-liquid crystal portion 32 without alteration of the optical path and then are converged by the aspherical convex lens type-liquid crystal portion 33. Thereafter, the convergent light beams are focused by the objective lens 150 onto an optical spot on a recording plane at position L₋₁ in the multilayer structure of the optical disc 160.

Application of 5V to the aspherical concave lens type-liquid crystal portion 12 causes the refractive index to change to 1.61. In this case (not shown), the parallel light beams incident on the variable refractive index element 30 diverge at a smaller angle then when 10 V are applied and then converge while passing through the aspherical convex lens type-liquid crystal portion 33. By the objective lens 150, the convergent light beams are further converged to form an optical spot on a virtual recording plane present between positions L₀ and L₋₁ in the optical disc 160.

Where an external electric field of 10 V is applied across the aspherical convex lens type-liquid crystal portion 33, that is, where the aspherical convex lens type-liquid crystal portion 33 is set to have a refractive index of 1.5 while the refractive indices of the glass plates 31 and the aspherical concave lens type-liquid crystal portion 32 remain at 1.5 and 1.72, respectively, the parallel light beams incident on the variable refractive index element 30, as indicated by dot and dashed lines, are diverged by the aspherical concave lens type-liquid crystal portion 32 and then converged by the aspherical convex lens type-liquid crystal portion 33 at a smaller angle in relation to when no external electric field is applied. Thereafter, the convergent light beams are focused by the objective lens 150 onto an optical spot on a recording plane at position L₊₁ in the multilayer structure of the optical disc 160.

The application of 5V to the aspherical convex lens type-liquid crystal portion 33 causes the refractive index to change to 1.61. In this case (not shown), the parallel light beams incident on the variable refractive index element 10 are diverged by the aspherical concave lens type-liquid crystal portion 32 and then converged by the aspherical convex lens type-liquid crystal portion 33 at a larger angle than when 10 V are applied. By the objective lens 150, the convergent light beams are further converged to form an optical spot on a virtual recording plane present between positions L₀ and L₊₁ in the optical disc 160.

Instead of the concave or convex lenses described in the above embodiments, meniscus lenses may be employed. In this case, the focus distance may be shortened using the same thickness lens, that is, 10 μm, but the aberration compensating ability may be somewhat degraded.

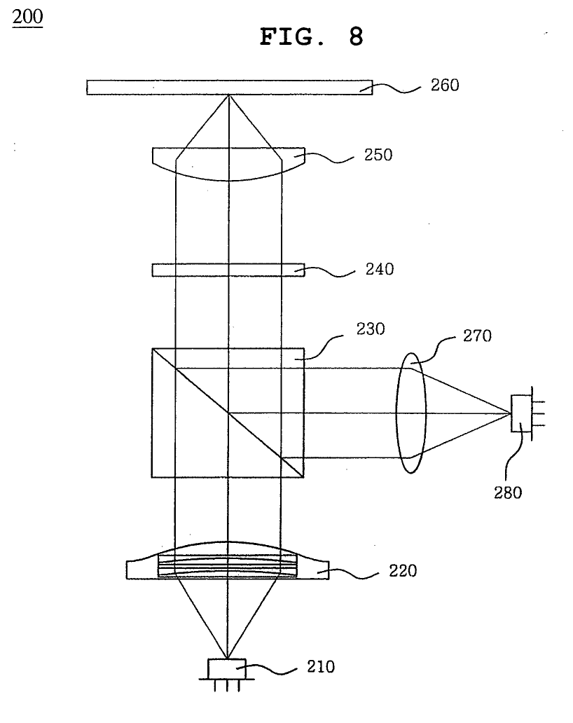

FIG. 8 depicts a structure of an optical pickup device 200 in accordance with another embodiment of the present invention, which employs an integrated collimate lens with a variable refractive index element built therein. A description will be given of embodiments of optical pickup devices which are adapted to BDs. If different optical discs, CDs or DVDs, are used, necessary parts such as objective lenses may be modified or supplemented.

The optical pickup device 200, as depicted in FIG. 8, comprises a radiating element 210, a collimate lens 220, a polarized beam splitter 230, a quarter wave plate 240, an objective lens 250, a focal lens 270, and a photodetector 280.

After being emitted from the radiating element 210, 405 nm blue light beams with a plane of polarization are transmitted to the collimate lens 220.

In the collimate lens 220, all of the optical paths that the light beams keep after the light source, are made to be almost parallel to the optical axis. The parallel light is directed to the polarized beam splitter 230. At this time, the light beams incident on the collimate lens 220 are refracted by the variable refractive index element built in the collimate lens 220, so that the traveling path of the parallel light beams depends on the refractive index of the element.

The polarized beam splitter 230 allows the parallel light to pass therethrough, but reflects at a right angle the light reflected from an optical disc. After passing through the polarized beam splitter 230, the parallel light goes to the quarter wave plate 240 while the light reflected at a right angle from the polarized beam splitter 230 is forwarded to the focal lens 270.

The quarter wave plate 240 changes the parallel light incident thereon from linearly polarized light into circularly polarized light and vice versa. Thus, the linearly polarized light incident on the quarter wave plate 240 is changed into circularly polarized light which is then transmitted to the objective lens 250. On the other hand, the light reflected from the optical disc 260 changes from circularly polarized light to linearly polarized light in the quarter wave plate 240 before being forwarded to the polarized beam splitter 230.

Through the objective lens 250, the parallel light beams transmitted from the quarter wave plate 240 are converged into a recording plane of a corresponding layer formed in the optical disc 260. Also, the objective lens 250 serves to collimate the light beams reflected from the optical disc before the reflected light beams travel to the quarter wave plate 240. As for the spot position of the light beams, it is determined by the variable refractive index element integrated in the collimate lens 220. Because the light beams from the light source are refracted many times by the variable refractive index element, their optical path varies depending on the refraction extent at the variable refractive index element, thus determining the position of the optical spot in the optical disc 260. By controlling the refractive index of the variable refractive index element, therefore, optical spots can be accurately formed on a desired recording layer in a multilayer-structured BD so as to write or read information.

Positioned between the polarized beam splitter 230 and the photodetector 280, the focal lens 270 converges the light reflected from the polarized beam splitter 230 onto the photodetector 280 which converts the reflected light into electrical signals to read the information.

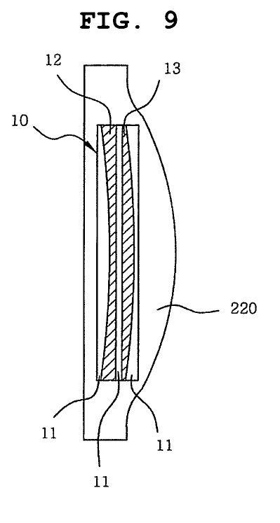

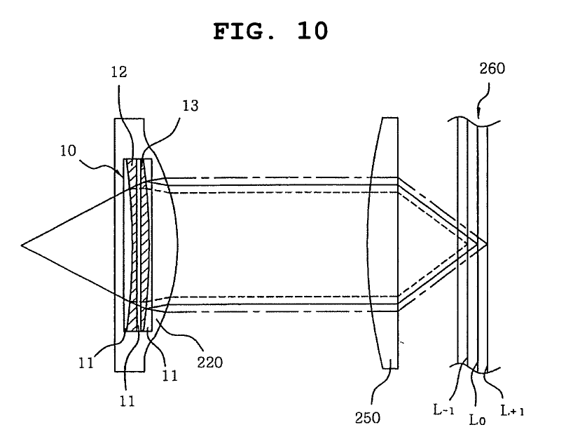

The variable refractive index elements built in the collimate lens 220 applied to the optical pickup device of FIG. 8 can be structured in various formats which are explained in detail with reference to FIGS. 9 to 11.

FIG. 9 shows an integral collimate lens 220 in which the same variable refractive index element 10 as described in FIGS. 2 to 5 is built. Even if the variable refractive index element 10 comprising the concave lens type-liquid crystal portion 12 and the convex lens type-liquid crystal portion 13 is depicted in FIG. 9, the variable refractive index element 20 comprising the convex lens type-liquid crystal portions 22 and 23, or the variable refractive index element 30 comprising the spherical liquid crystal portions 32 and 33, which are described in FIGS. 6 and 7, may be employed, instead.

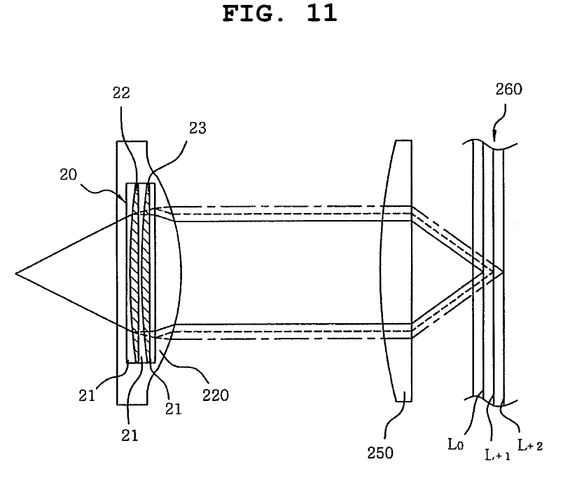

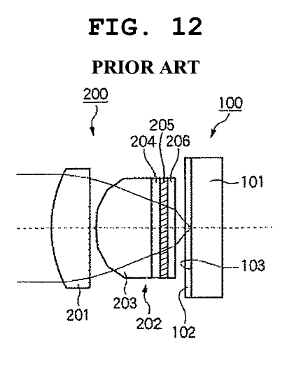

The variable refractive index element 10 comprising the concave lens type-liquid crystal portion 12 and the convex lens type-liquid crystal portion 13 differs in the extent of refraction from the variable refractive index element 30 comprising the aspherical liquid crystal portions 32 and 33. However, the variable refractive index elements 10 and 30 allow light beams passing therethrough to take similar optical paths in correspondence with the refractive index change due to the external electric field applied thereto. For this reason, the optical paths based on the variable refractive index element 30 may refer to that based on the variable refractive index element 10, which is described in detail below with reference to FIG. 10.

When no external electric field is applied, that is, when the glass plates 11, the concave lens type-liquid crystal portion 12 and the convex lens type-liquid crystal portion 13 have refractive indices of 1.5, 1.72 and 1.72, respectively, the light beams incident on the collimate lens 220, as indicated by solid lines, are refracted many times at predetermined angles and then are emergent as parallel light beams, followed by the concentration of the parallel light beams by the objective lens 250 to form an optical spot on a recording plane at position L₀ in the multilayer structure of the optical disc 260.

On the other hand, when 10 V are applied across the concave lens type-liquid crystal portion 12, its refractive index is changed to 1.5 while the refractive indices of the glass plates 11 and the convex lens type-liquid crystal portion 13 remain at 1.5 and 1.72, respectively. In this circumstance, the light beams incident on the collimate lens 220, as indicated by dotted lines, are refracted many times at predetermined angles and then are emergent as parallel light beams. Thereafter, the parallel light beams are focused by the objective lens 250 onto an optical spot on a recording plane at position L₋₁ in the multilayer structure of the optical disc 260.

Where an external electric field of 10 V is applied across the convex lens type-liquid crystal portion 13, that is, where the convex lens type-liquid crystal portion 13 is set to have a refractive index of 1.5 while the refractive indices of the glass plates 11 and the concave lens type-liquid crystal portion 12 remain at 1.5 and 1.72, respectively, the light beams incident on the collimate lens 220, as indicated by dot and dashed lines, are refracted many times at predetermined angles and then are emergent as parallel light beams. Thereafter, the parallel light beams are focused by the objective lens 250 onto an optical spot on a recording plane at position L₊₁ in the multilayer structure of the optical disc 260.

With reference to FIG. 11, a description is given of optical paths of the light beams passing through the collimate lens 220 in which a pair of convex lens type-liquid crystal portions 22 and 23.

In the absence of the application of an external electric field, that is, when glass plates 21 and the pair of convex lens type-liquid crystal portions 22 and 23 have refractive indices of 1.5, 1.72 and 1.72, respectively, light beams incident on the collimate lens 220, as indicated by solid lines, are refracted many times at predetermined angles and then are emergent as parallel light beams, followed by the concentration of the parallel light beams by the objective lens 250 to form an optical spot on a recording plane at position L₀ in the multilayer structure of the optical disc 260.

On the other hand, when 10 V are applied across the convex lens type-liquid crystal portion 22, its refractive index is changed to 1.5 while the refractive indices of the glass plates 21 and the convex lens type-liquid crystal portion 23 remain at 1.5 and 1.72, respectively. In this circumstance, the light beams incident on the collimate lens 220, as indicated by dotted lines, are refracted many times at predetermined angles and then are emergent as parallel light beams. Thereafter, the parallel light beams are focused by the objective lens 250 onto an optical spot on a recording plane at position L₊₁ in the multilayer structure of the optical disc 260.

Where an external electric field of 10 V is applied across both of the convex lens type-liquid crystal portions 22 and 23, that is, where all the glass plates 21 and the convex lens type-liquid crystal portions 22 and 23 have the same refractive index of 1.5, the light beams incident on the collimate lens 220, as indicated by dot and dashed lines, are refracted many times at predetermined angles and then emergent as parallel light beams. Thereafter, the parallel light beams are focused by the objective lens 250 onto an optical spot on a recording plane at position L₊₂ in the multilayer structure of the optical disc 260.

Instead of the concave or convex lenses described in the above embodiments, meniscus lenses may be employed. In this case, the focus distance may be shortened even with the same thickness, that is, 10 μm, but aberration compensating ability may be somewhat degraded.

Results of aberration correction obtained by use of the variable refractive index elements in the above-described optical pickup devices are summarized in the following tables. In the optical pickup devices, blue light beams with a wavelength of 400±5 nm were used in combination with an NA of 0.85 and an the element having an effective radius of 3.0 mm and a thickness of 0.1 mm performed at a working distance of 0.675 mm.

The variable refractive index elements used have the specifications shown in Table 1, below.

TABLE 1

| Variable | | | |
|---|---|---|---|
| Refractive | Curvature | Thick. | |
| Index Elements | Radii(mm) | (μm) | Shapes |
| 1^{st} | 144.5 | 10 | Concave + Convex |
| 2^{nd} | 72.25 | 20 | Concave + Convex |
| 3^{rd} | 144.5 | 10 | Aspherical |

Spherical aberrations due to the variation in thickness of BDs are given in Table 2, below.

TABLE 2

| Thick.(mm) | Abberations(RMS) |
|---|---|
| 0.1 ± 0.00 | 0.0003 |
| 0.1 ± 0.01 | 0.0973 |
| 0.1 ± 0.02 | 0.1944 |
| 0.1 ± 0.03 | 0.2917 |
| 0.1 ± 0.04 | 0.3890 |
| 0.1 ± 0.05 | 0.4865 |

The aberration correction capacities of the 1^{st}, the 2^{nd} and the 3^{rd} variable refractive index element of Table 1 are given in Table 3, below.

TABLE 3

| Variable Refractive | Max. Aberration |
|---|---|
| Index Elements | Corrections(RMS) |
| 1^{st} | 0.0740 |
| 2^{nd} | 0.1411 |
| 3^{rd} | 0.5432 |

Results from the correction for the spherical aberration due to the variation in thickness by the use of the 1^{st}, the 2^{nd} and the 3^{rd} variable refractive index element are given in Table 4, below.

TABLE 4

| Variable Refractive | Thickness | Aberrations |
|---|---|---|
| Index Elements | Variation (mm) | Corrected(RMS) |
| 1^{st} | 0.1 + 0.01 | 0.0209 |
| 1^{st} | 0.1 − 0.01 | 0.0202 |
| 2^{nd} | 0.1 + 0.02 | 0.0433 |
| 2^{nd} | 0.1 − 0.02 | 0.0389 |
| 3^{rd} | 0.1 + 0.05 | 0.0754 |
| 3^{rd} | 0.1 − 0.05 | 0.0683 |

It is evident from the results of Tables 1 to 4 that when account is taken of the fact that a BD usually has recording planes partitioned into two layers with an interlayer distance of approximately 25 μm, the first variable refractive index element having a curvature radius of 144.5 mm and a thickness of 10 μm can be adapted to BDs having double recording layers because its correction for spherical aberration is in the range of approximatey ±20 μm (0.002 mm).

In addition, the second variable refractive index element with a curvature radius of 72.25 mm and a thickness of 20 μm has a spherical aberration correction range of approximately ±40 μm (0.004 mm) so that it can be applied to BDs which have at least two recording layers. In consideration of the fact that the distance between recording layers of BDs is not fixed at 25 μm but differs from one manufacturer of BDs to another, the second variable refractive index element can be applied to BDs having triple recording layers with an interlayer distance of about 13 μm. Furthermore, when a spherical element, like the first or the second variable refractive index element, is used, its correction for spherical aberration can be in the range of ±50 μm by increasing the thickness of the liquid crystal portion to 30-40 μm, which makes it possible to adapt the variable refractive index element to BDs having as many as five recording layers.

In the case of employing the third variable refractive index element which is aspherical, the correction for spherical aberrations is in the range of ±50 μm so that the element can be adapted to BDs having five recording layers. Moreover, an increase in thickness of the liquid crystal portion of the aspherical element may result in expanding the range of spherical aberration correction to more than ±50 μm.

Including at least two liquid crystal portions each of which has an incident or emergent plane with a curvature, as described hereinbefore, the variable refractive index element used has a more useful refractive index than conventional flat variable refractive index elements. Therefore, the optical pickup devices according to the present invention can write on and read from a 100 μm-thick BD having multi-recording layers, thereby greatly enhancing the recording density of optical discs.

In contrast to conventional ones, the optical pickup device of the present invention needs no additional objective lenses by virtue of the variable refractive index element, thus enjoying the advantage of being simple in structure and having a light weight.

Although the embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. An optical pickup device, comprising:
a radiating element for radiating light beams;
an objective lens for focusing the light beams onto an optical disc;
a photodetector for receiving light beams reflected from the optical disc; and
a variable refractive index element having a predetermined curvature radius on at least one of its surfaces and a refractive index that varies upon the application of an external electrical field for refracting and transmitting the light beams from the radiating element onto the objective lens.

2. The optical pickup device as set forth in claim 1, wherein the variable refractive index element comprises:
a plurality of transparent protecting portions, and
a plurality of liquid crystal portions within the transparent protecting portions, the liquid crystal portions having a predetermined curvature radius on at least one of its surfaces and a refractive index that varies upon the application of an external electrical field.

3. The optical pickup device as set forth in claim 2, wherein the plurality of liquid crystal portions comprises at least one concave lens type-liquid crystal portion as an incident plane and at least one convex lens type-liquid crystal portion as an emergent plane.

4. The optical pickup device as set forth in claim 3, wherein the concave lens type-liquid crystal portion and the convex lens type-liquid crystal portion are spherical or aspherical.

5. The optical pickup device as set forth in claim 2, wherein the plurality of liquid crystal portions comprises a pair of convex lens type-liquid crystal portions, each having a convex surface as an incident plane.

6. The optical pickup device as set forth in claim 5, wherein the pair of liquid crystal portions is spherical or aspherical.

7. The optical pickup device as set forth in claim 2, wherein the plurality of liquid crystal portions comprises at least one meniscus liquid crystal portion.

8. The optical pickup device as set forth in claim 7, wherein the meniscus liquid crystal portion is spherical or aspherical.

9. The optical pickup device as set forth in claim 2, wherein each of the liquid crystal portions has a thickness from 6 to 40 μm, and the curvature radius from 45.145 to 280 mm.

10. The optical pickup device as set forth in claim 2, wherein refractive indices of the plurality of liquid crystal portions varies from 1.5 to 1.72.

11. An optical pickup device with a variable refractive index, comprising:
a radiating element for radiating light beams;
a collimate lens for collimating the light beams from the radiating element;
an objective lens for focusing the light beams onto an optical disc;
a photodetector for receiving light beams reflected from the optical disc; and
a variable refractive index element having a predetermined curvature radius on at least one of its surfaces and a refractive index that varies upon the application of an external electrical field for refracting and transmitting the light beams from the radiating element onto the objective lens.

12. The optical pickup device as set forth in claim 11, wherein the variable refractive index element comprises:
a plurality of transparent protecting portions, and
a plurality of liquid crystal portions within the transparent protecting portions, the liquid crystal portions having a predetermined curvature radius on at least one of its surfaces and a refractive index that varies upon the application of an external electrical field.

13. The optical pickup device as set forth in claim 12, wherein the plurality of liquid crystal portions comprises:
at least one concave lens type-liquid crystal portion as an incident plane; and
at least one convex lens type-liquid crystal portion as an emergent plane.

14. The optical pickup device as set forth in claim 13, wherein the concave lens type-liquid crystal portion and the convex lens type-liquid crystal portion are spherical or aspherical.

15. The optical pickup device as set forth in claim 12, wherein the plurality of liquid crystal portions comprises a pair of convex lens type-liquid crystal portions, each having a convex surface as an incident plane.

16. The optical pickup device as set forth in claim 15, wherein the pair of liquid crystal portions is spherical or aspherical.

17. The optical pickup device as set forth in claim 12, wherein the plurality of liquid crystal portions comprises at least one meniscus liquid crystal portion.

18. The optical pickup device as set forth in claim 17, wherein the meniscus liquid crystal portion is spherical or aspherical.

19. The optical pickup device as set forth in claim 12, wherein each of the liquid crystal portions has a thickness from 6 to 40 μm, and the curvature radius from 45.145 to 280 mm.

20. The optical pickup device as set forth in claim 12, wherein refractive indices of the plurality of liquid crystal portions varies from 1.5 to 1.72.
